(19) United States
(12) Patent Application Publication
(10) Pub. No.: US 2016/0371987 A1
(43) Pub. Date: Dec. 22, 2016

(54) COMMAND AND CONTROL INTERFACE FOR UAVS COMMUNICATION THROUGH A MOBILE WIRELESS NETWORK

(71) Applicant: Verizon Patent and Licensing Inc., Arlington, VA (US)

(72) Inventor: Lalit R. Kotecha, San Ramon, CA (US)

(21) Appl. No.: 14/741,816

(22) Filed: Jun. 17, 2015

(51) Int. Cl. G08G 5/00; G08G 5/04; G05D 1/00

(52) U.S. Cl. CPC G08G 5/0043; G05D 1/0022; G08G 5/04; H04W 88/16

(57) ABSTRACT

A command and control gateway may implement a command and control interface for UAVs that are connected to a wireless network. In one implementation, the command and control gateway may communicate with the UAVs using network traffic that is assigned a high priority. The use of high priority traffic may provide for a command and control channel that has relatively low latency and low jitter.

### BACKGROUND

“Unmanned Aerial Vehicles” (UAVs) (sometimes referred to as “drones” or Remotely Piloted Aircraft (RPA)) refer to aircraft without a human pilot aboard. The flight of a UAV may be controlled either autonomously (e.g., by onboard and/or remote computers) or by the remote control from a pilot. One proposed use of UAVs is for the delivery of payloads (e.g., packages).

In either autonomous or remote control operation, it may be desirable that the UAV maintain network connectivity to the command and control location (i.e., the physical location of the pilot and/or control processes). From the command and control location, the UAV may receive navigation instructions, emergency instructions (e.g., take evasive action to avoid a collision), or other instructions relating to command and control of the UAV.

### BRIEF DESCRIPTION OF THE DRAWINGS

Embodiments of the present invention will be readily understood by the following detailed description in conjunction with the accompanying drawings. To facilitate this description, like reference numerals may designate like structural elements.

FIG. 1 is a diagram illustrating an example of an overview of concepts described herein;

FIG. 2 is a diagram illustrating an example environment in which systems and/or methods described herein may be implemented;

FIG. 3 is a diagram conceptually illustrating an example of the operation of a command and control gateway;

FIG. 4 is a diagram illustrating one example of Quality of Service (QoS) Class Identifier (QCI) level mapping, for a wireless network;

FIG. 5 is a flowchart illustrating an example process relating to the operation of a command and control gateway;

FIG. 6 is a diagram illustrating an example application of the command and control interface;

FIG. 7 is a diagram illustrating another example application of the command and control interface; and

FIG. 8 is a diagram of example components of a device.

### DETAILED DESCRIPTION F PREFERRED EMBODIMENTS

The following detailed description refers to the accompanying drawings. The same reference numbers in different drawings may identify the same or similar elements.

Techniques described herein relate to a command and control interface for UAVs that are controlled through a wireless network, such as a cellular wireless network. The command and control interface may be implemented by a command and control gateway, or other network device, that is provided by an operator of the wireless network. UAV operators may control the flight of UAVs by transmitting commands to the command and control gateway, which may forward the commands, via the wireless network, to the UAVs.

In one implementation, the command and control gateway may communicate with the UAVs using network traffic that is assigned a high priority. The high priority network traffic may be set to a Quality of Service (QoS) priority level that is of higher priority than network voice traffic. The use of high priority traffic may provide for a command and control channel that has relatively low latency and low jitter. This can be particularly desirable for real-time control of UAVs during flight. Because the command and control channel may be limited to being only used for command and control traffic with UAVs, the bandwidth requirements on the network, for the high priority network traffic, may be relatively low.

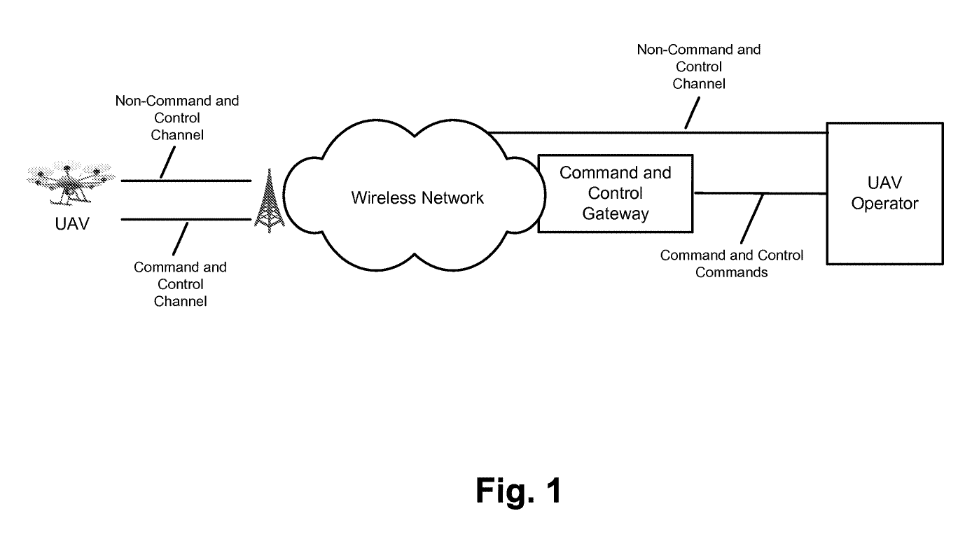

FIG. 1 is a diagram illustrating an example of an overview of concepts described herein. As shown in FIG. 1, a UAV may be controlled by a UAV operator. Communications with the UAV may be performed through a wireless network, such as a wireless cellular network. A command and control gateway may be provided by an operator of the wireless network. The command and control gateway may act as a unified interface through which UAV operators may communicate command and control related communications to the UAVs.

Communications associated with the command and control gateway are illustrated in FIG. 1 as being part of the “command and control channel.” Data transmitted as part of the command and control channel may be given high priority. For example, command and control channel traffic may have the highest level of network priority. Accordingly, the command and control channel may be associated with low latency and low jitter communications. Non-command and control traffic, on the other hand, may be transmitted as “normal” (e.g., best effort) data traffic in the wireless network (or as some other priority that is lower than the priority of the command and control channel). The non-command and control traffic may include any traffic with the UAV that is not related to command and control of the UAV (e.g., images taken by the UAV). The non-command and control traffic may not be handled by the command and control gateway.

By providing a single unified interface for the UAV command and control traffic, operator override and/or regulatory compliance considerations may be efficiently handled. For example, regulators and/or public safety organizations may be given “override” access to the command and control gateway, potentially allowing the regulators/public safety organizations to issue emergency commands (e.g., hover or land) to all UAVs within a particular geographic region, monitor the flight path of UAVs within certain regions, and/or obtain regulatory compliance reports relating to the flight of UAVs (e.g., to ensure that a UAV operator does not cause a UAV to fly in a restricted area).

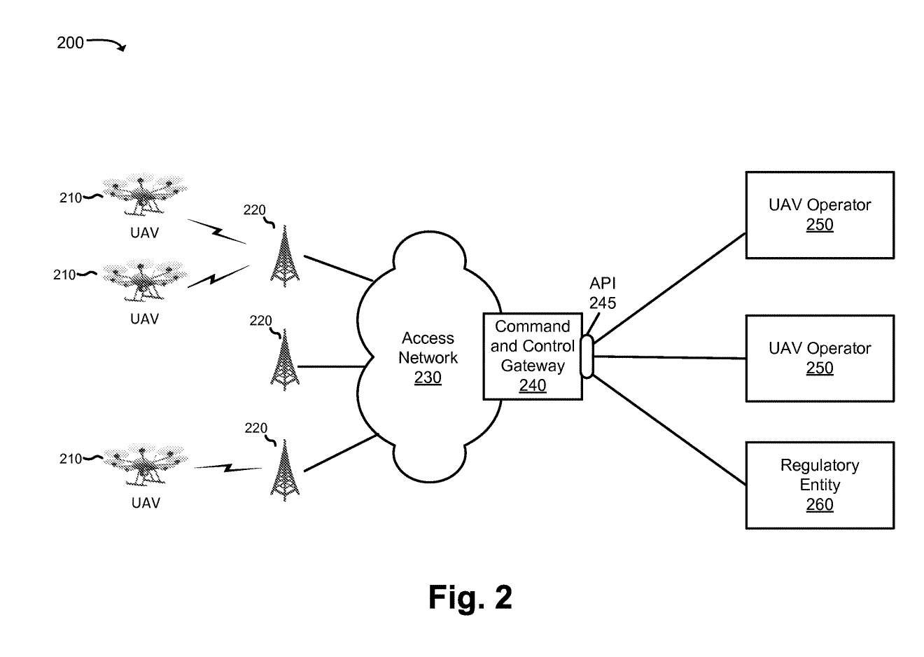

FIG. 2 is a diagram illustrating an example environment 200 in which systems and/or methods described herein may be implemented. As shown, environment 200 may include UAVs 210, base stations 220, access network 230, command and control gateway 240, UAV operators 250, and regulatory entity 260.

UAVs 210 may each include a remotely piloted aerial device, such as a quadcopter or other helicopter-based design, a winged flying device, a blimp, etc. UAV operators 250 may include public or private entities that may use UAVs to deliver payloads or to provide other UAV-based services (e.g., landscape monitoring or photography, agricultural services, etc.). UAVs 210 may each include radio communication equipment that enables UAV 210 to wirelessly communicate with a cellular wireless network, such as one implemented by base stations 220 and access network 230.

Base stations 220 may include base stations for a wireless cellular network. Each base station 220 may include one or more radio transceivers to provide wireless connections to mobile devices (such as UAVs 210). In the context of a Long Term Evolution (LTE) network, base station 220 may be implemented by an Evolved Node B (eNodeB). In the context of a Global System for Mobile (GSM) communications network, base station 220 may be implemented by a base transceiver station (BTS). Base stations 220 may also include small cells, such as femtocells, microcells, etc. Base stations 220 may generally function to provide an air (radio) interface over a large geographical area. Base stations 220 may be geographically arranged to each provide coverage for a limited geographical area (a “cell”). Mobile devices, such as UAVs 210, when moving in and out of the coverage area of particular base stations 220, may be “handed off” to different base stations to receive, from the standpoint of the mobile device, uninterrupted network coverage.

Access network 230 may represent a network, such as one implemented by the operator of base stations 220, that is used to connect base stations 220 and to provide network management and backhaul functionality. Access network 230 may also provide connectivity to mobile devices, such as UAVs 210, to external servers or networks, such as to UAV operator 250.

In an implementation in which the wireless network includes an LTE-based network, access network 230 may include an evolved packet core (EPC) network that operates based on a third generation partnership project (3GPP) wireless communication standard. The EPC network may include one or more serving gateways (SGWs), mobility management entities (MMEs), and/or packet data network gateways (PGWs).

Access network 230 may be additionally associated with command and control gateway 240. Command and control gateway 240 may include one or more computing devices that act as a unified command and control interface to UAVs 210. Command and control gateway 240 may be implemented as part of access network 230 and/or external to access network 230. For example, command and control gateway 240 may include an Application Programming Interface (API) 245 that is designed to provide access, to UAV operators 250, to UAV commands relating to command and control. The commands relating to command and control may include, for example, commands that allow UAV operator 250 to control the speed, direction, and height of UAVs 210, to receive expedited delivery of certain sensor data (e.g., collision avoidance data), and to provide emergency landing or hovering commands.

In one implementation, command and control gateway 240 may include logic to control UAVs 210. Based on status information (e.g., location updates, sensor information, etc.) received from UAVs 210, command and control gateway 240 may control UAVs 210. For example, when a UAV approaches too closely to a restricted area, command and control gateway 240 may override control by UAV operator 250 and instruct the UAV to stop moving (perform a hover operation). UAV operator 250 may be notified of the override and may be given an opportunity to control the UAV to navigate away from the restricted area.

UAV operators 250 may each represent an operator of one or more UAVs 210. Through wireless communications with the UAVs, UAV operators 250 may control flight paths taken by UAVs 210 and other operations performed by UAVs 210. UAV operators 250 may use command and control gateway 240 (e.g., by accessing API 245) to communicate command and control information to UAVs 210.

Regulatory entity 260 may represent a regulatory entity, such as a public safety entity, that is to monitor the flights of UAVs 210 (e.g., for safety violations) and/or that is provided with authority to take full or partial control of UAVs during a public emergency or during other specified periods or situations.

The quantity of devices and/or networks, illustrated in FIG. 2, is provided for explanatory purposes only. In practice, there may be additional devices and/or networks; fewer devices and/or networks; different devices and/or networks; or differently arranged devices and/or networks than illustrated in FIG. 2. Alternatively, or additionally, one or more of the devices of environment 200 may perform one or more functions described as being performed by another one or more of the devices of environment 200.

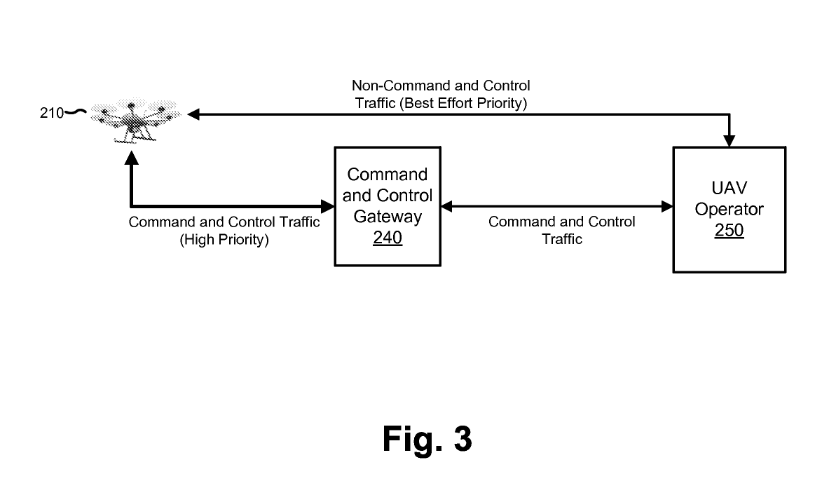

FIG. 3 is a diagram conceptually illustrating an example of the operation of command and control gateway 240. As shown, UAV operator 250, instead of transmitting/receiving command and control traffic directly with UAV 210, may instead communicate with command and control gateway 240. For example, as previously mentioned, a network operator may provide an API 245, which may represent a standardized command interface through which UAV operators 250 may control UAVs 210. Command and control traffic, as used herein, may refer to communications, with UAV 210, relating to navigation of the UAV (e.g., control of the speed, height, and direction of the UAV) or to traffic relating to emergency operation of UAVs 210, such as commands requiring UAVs 210 to hover, perform an emergency landing, perform evasive action with respect to another nearby device, etc. In some situations, command and control traffic may include traffic that relays time sensitive sensor data. For example, certain sensor readings that are measured by UAV 210, such as sensor readings related to potential collision conditions, may be communicated in the command and control traffic.

In some implementations, command and control gateway 240 may enforce a uniform command protocol relating to UAV commands. For example, commands relating to UAV navigation (e.g., a command causing a UAV to fly at a particular speed, a particular altitude, or a command requesting the current location of UAV 210) may be standardized across all UAV operators. Command and control gateway 240 may enforce standardization of certain UAV commands by providing API 245 as an API that requires that UAV commands be specified in a particular (standardized) manner. Standardization of command and control traffic may allow for more efficient regulatory monitoring and emergency control.

The command and control traffic may be communicated as high priority traffic within the wireless network (e.g., within access network 230 and via base stations 220). For LTE networks, QoS Class Identifier (QCI) values may be assigned to bearer traffic. Traffic with different QCI values may be provided different priority treatment by the network. Conventionally, QCI values may be assigned between 1 and 9, in which 1 indicates the highest priority level and 9 indicates the lowest priority level. When congestion is encountered, lower priority level traffic may be the first to be discarded and/or delayed. Consistent with aspects described herein, bearers used to transmit the command and control traffic may be assigned a high priority level. In one implementation, the QCI value for the command and control traffic may be set at 1. Voice traffic, which is conventionally assigned a high QCI priority (such as a QCI value of one) may be reassigned to have a lower priority value. Alternatively, a new QCI value may be defined (e.g., QCI value of zero) and configured in the network. The command and control traffic may be assigned the new QCI value and may thus be given higher priority than all other existing bearer traffic.

Non-command and control traffic is also illustrated in FIG. 3. The non-command and control traffic may include best effort (e.g., QCI value of 9) traffic that is not processed by command and control gateway 240. The non-command and control traffic may include any communications between UAV 210 and UAV operator 250 that are not command and control related. The non-command and control traffic may include, for example, images, sensor measurements, or other data that is gathered or produced by UAV 210 but that is not command and control traffic. Additionally, the non-command and control traffic may include commands, for UAV 210, that are not time-sensitive. For example, a command directing UAV 210 to control the focus of a camera may be a command that is not considered a command and control command, and the command may thus be communicated as the non-command and control traffic.

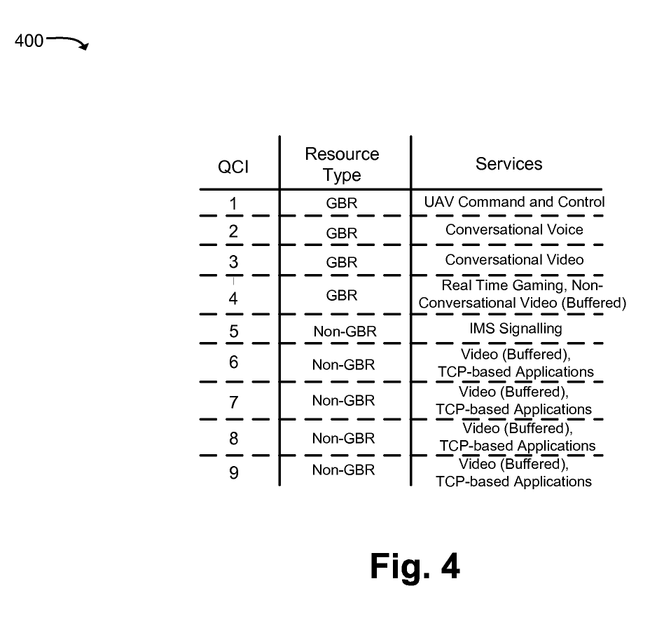

FIG. 4 is a diagram illustrating one example of QCI level mapping, for a wireless network, in which UAV command and control traffic is given highest priority processing.

As shown in FIG. 4, UAV command and control traffic may be assigned a QCI value of 1, which may correspond to guaranteed bit rate (GBR) traffic. The UAV command and control traffic may thus be associated with the highest priority traffic. In this manner, the UAV command and control traffic may be guaranteed to be relatively low latency and low jitter traffic. In the example of FIG. 4, voice traffic (“conversational voice”) is assigned a QCI value of 2, video traffic (“conversational video”) is assigned a QCI value of 3, and real-time gaming traffic and video (such as live streaming video) is assigned a QCI value of 4. The traffic having QCI values 1-4 may be GBR traffic while the traffic having QCI values of 5-9 may be non-GBR traffic. As shown, the non-GBR traffic may include IMS signaling traffic (QCI value of 5), and various video and TCP-based application traffic (e.g., email, chat, file transfer, etc.), which are assigned QCI values of 6-9.

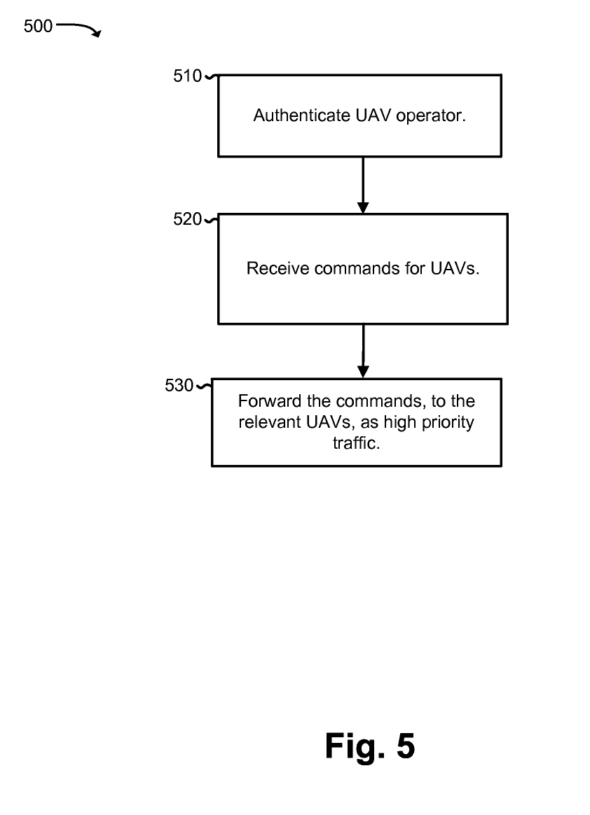

FIG. 5 is a flowchart illustrating an example process 500 relating to the operation of command and control gateway 240. Process 500 may be implemented by command and control gateway 240.

Process 500 may include authenticating UAV operators (block 510). The authentication may be performed using password-based authentication or other authentication techniques. The authentication may be necessary in order to determine the privileges or permissions relating to a particular UAV operator. As previously mentioned, UAV operators 250 may use command and control gateway 240 as a unified access point for commands sent to UAVs 210. Different UAV operators 250 may be associated with different privileges or permissions relating to control of UAVs. For example, “standard” UAV operators 250 may only be able to send commands, via UAV operator 250, to UAVs operated by the particular operator. Regulatory entity 260, on the other hand, may be given a higher privilege level, such as the ability to transmit commands to all of UAVs 210 and/or to be able to transmit emergency commands that may be associated with all UAVs 210 or all UAVs 210 that are within a particular geographical area. For instance, as previously mentioned, regulatory entity 260 may be able to transmit commands to cause UAVs 210 to immediately land or hover.

Process 500 may further include receiving commands for UAVs (block 520). The commands may be commands related to command and control. The commands may be received from UAV operator 250 and/or regulatory entity 260. In some implementations, a particular command may be broadcast command. For example, a UAV operator may wish to broadcast a particular command to all UAVs that are under control of the operator. In response, command and control gateway 240 may initiate a broadcast to all of the UAVs that are under control of the operator. In other situations, a UAV command may be a command that is specified for a particular UAV.

Process 500 may further include forwarding received commands, to the relevant UAVs, as high priority traffic (block 530). Because the command transmitted through wireless cellular network is transmitted as high priority traffic, the commands may be guaranteed to efficiently arrive at destination UAVs 210. As previously mentioned, for an LTE cellular network, the high priority traffic may be traffic assigned a QoS QCI value of one (i.e., highest priority). Using high priority traffic may result in a command and control interface with low latency, low jitter, and/or low data error rates. Accordingly, the commands, which may include real-time commands that are generated based on operating conditions of the UAV, may be guaranteed to arrive quickly and error-free that the UAV.

Although process 500 was discussed in the context of transmitting command and control commands from command and control gateway 240 to UAVs 210, command and control commands may also be transmitted, as high priority traffic, from UAVs 210 to command and control gateway 240. Command and control gateway 240 may forward the information received from UAVs 210 to the UAV operator 250 that is associated with the UAVs. In this manner, the command and control gateway may provide a command and control interface, in both the uplink and downlink direction, for command and control traffic.

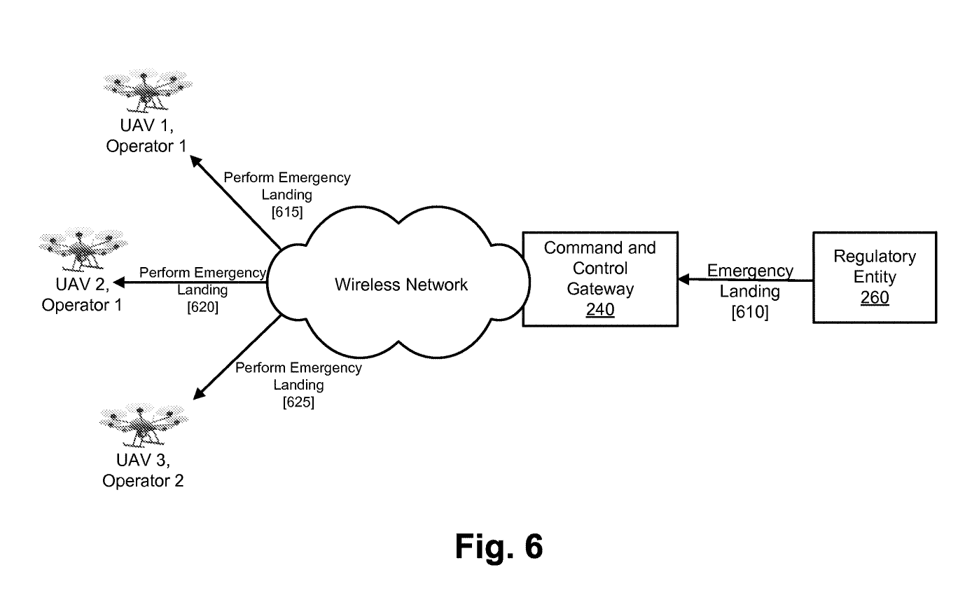

FIG. 6 is a diagram illustrating an example application of the command and control interface. In FIG. 6, assume a number of UAVs are operating and are connected to a wireless network, labeled as “UAV 1, Operator 1,” “UAV 2, Operator 1,” and “UAV 3, Operator 2.” Thus, two of the UAVs (UAV 1 and UAV 2) may be associated with a first UAV operator (Operator 1) and one of the UAVs (UAV 3) may be associated with a second UAV operator (Operator 2). Additionally, regulatory entity 260, which may be a government entity that performs public safety functions associated with UAVs, communicates with command and control gateway 240.

At some point, regulatory entity 260 may be aware of an emergency situation that requires all the UAVs that are flying within a particular geographic area to land. For example, there may be suspicion of a terrorist threat or there may be a sudden weather event (e.g., a detected tornado) that may cause flying UAVs to be a danger to the public. Regulatory entity 260 may transmit a command, to command and control gateway 240, that directs that all UAVs within a specified geographical area (e.g., near in a particular city, zip code, etc.) to immediately land. Command and control gateway 240 may verify that regulatory entity 260 has authority to issue the command. After successful verification, command and control gateway 240 may determine all of the UAVs that are within the specified geographical area. Command and control gateway 240 may, for instance, receive periodic locations updates from UAVs connected to the wireless network. At any given time, command and control gateway 240 may thus be aware of the location of the UAVs that are connected to the wireless network and may be able identify the UAVs within a particular geographic area.

In this example, assume command and control gateway 240 identifies UAV 1, UAV 2, and UAV 3 as the UAVs that are currently flying and are within the particular geographic area. Command and control gateway 240 may corresponding transmit a command, to each of the three UAVs, indicating that the UAVs should perform an emergency landing (at 615, 620, and 625). In some implementations, the command may be transmitted as a broadcast type command. Alternatively or additionally, the command may be transmitted as a unicast command that is separately transmitted to each of the identified UAVs.

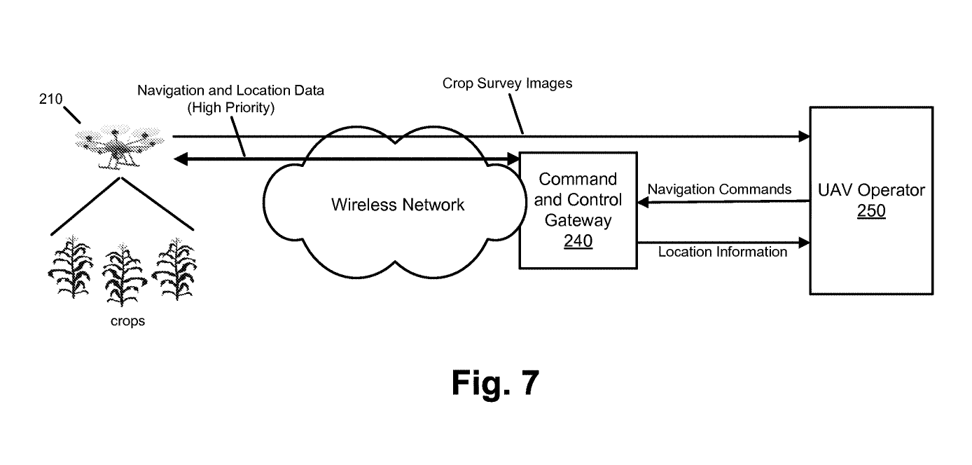

FIG. 7 is a diagram illustrating another example application of the command and control interface. In FIG. 7, UAV 210 may include a UAV that is to survey agriculture crops. The UAV may, for example, take images of the crops for later analysis by a farmer or other entity. The UAV may be remotely controlled by UAV operator 250.

Navigation commands relating to the flight of the UAV 210 may be generated, by UAV operator 250, and forwarded to UAV 210, via high priority traffic, through command and control gateway 240. The navigation commands may control the flight path of UAV 210. UAV 210 may transmit location information (e.g., geographical coordinate information obtained via a global positioning system (GPS) onboard UAV 210), indicating the location of UAV 210, to command and control gateway 240. The location information may be considered to be command and control information and may thus be transmitted as high priority traffic through the wireless network. Command and control gateway 240 may track the current location of UAV 210 and may forward the location information to UAV operator 250.

UAV 210 may capture images of the crops that are being surveyed by UAV 210. The images may be transmitted to UAV operator 250. Unlike the location information, the survey images may not be classified as command and control information, and may thus be transmitted as non-command and control traffic. For example, the images may be transmitted as “best effort” application traffic. As one example, the command and control traffic may be transmitted as QCI value 1 traffic, and the non-command and control traffic may be transmitted as QCI value 8 traffic.

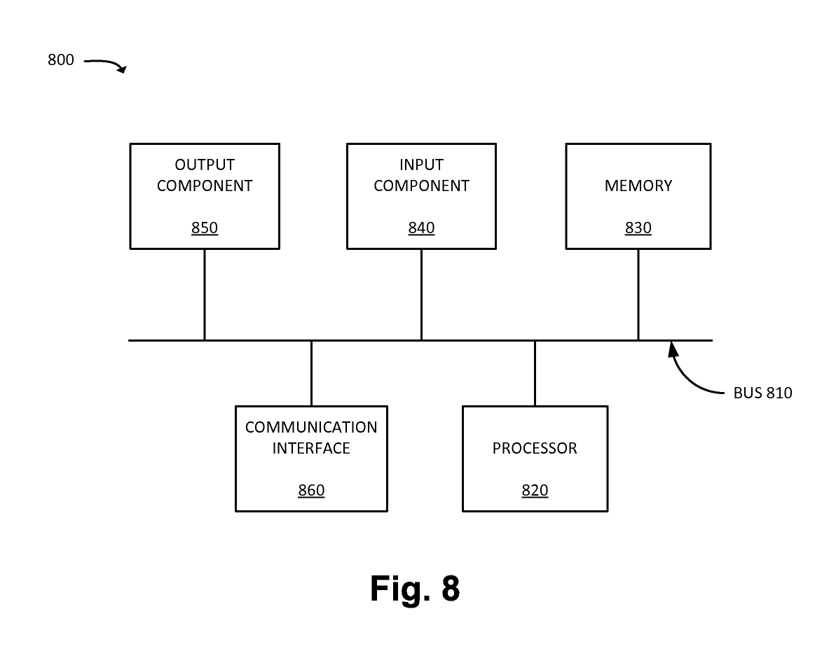

FIG. 8 is a diagram of example components of device 800. One or more of the devices described above (e.g., with respect to FIGS. 1, 2, 3, 6 and/or 7) may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may include processing circuitry to interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more light emitting diodes (LEDs), etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (IR) receiver, a Bluetooth radio, a cellular radio transceiver, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while a series of blocks have been described with regard to FIG. 5, the order of the blocks may be modified in other implementations. Further, non-dependent blocks may be performed in parallel.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A gateway device for a wireless network, the gateway device comprising processing circuitry to:
provide an interface, for operators of Unmanned Aerial Vehicles (UAVs) that are connected to the wireless network, to receive commands, from the operators, relating to control of the UAVs;
transmit the received commands, via the wireless network and to the UAVs, as network traffic that is assigned a priority level that is higher than voice traffic;
receive a command, from a regulatory or public safety entity, relating to one or more of the UAVs; and
override the received commands, from the operators of the UAVs, based on the command received from the regulatory or public safety entity, to control the one or more UAVs based on the command from the regulatory or public safety entity.

2. The gateway device of claim 1, wherein the gateway device further comprises processing circuitry to:
track the location of the UAVs that are connected to the wireless network.

3. The gateway device of claim 2, wherein the one or more UAVs, that are controlled by the command from the regulatory or public safety entity, are determined based on the tracked location of the UAVs.

4. The gateway device of claim 1, wherein the assigned priority level is associated with a Quality of Service (QoS) Class Identifier (QCI) value of one.

5. The gateway device of claim 1, wherein the gateway device further comprises processing circuitry to:
receive network traffic, from the UAVs, relating to UAV sensor data that is relevant to collision avoidance.

6. The gateway device of claim 1, wherein the command from the regulatory or public safety entity includes a command to direct the one or more UAVs to perform an emergency landing or hover operation.

7. The gateway device of claim 1, wherein the gateway device further comprises processing circuitry to:
detect when one or more of the UAVs approaches a restricted flying area; and
override control of the UAVs, by the UAV operators, in response to detection that the one or more of the UAVs is approaching the restricted flying area.

8. The gateway device of claim 1, wherein the interface provided by the gateway device includes an Application Programming Interface (API) that accepts a standardized set of commands relating to control of the UAVs.

9. A method, implemented by a gateway device for a wireless network, the method comprising:
receiving, by the gateway device and from operators of Unmanned Aerial Vehicles (UAVs) that are connected to the wireless network, commands relating to control of the UAVs;
transmitting the received commands, via the wireless network and to the UAVs, as network traffic that is assigned a priority level that is higher than voice traffic;
receiving a command, from a regulatory or public safety entity, relating to one or more of the UAVs; and
overriding the received commands, from the operators of the UAVs, based on the command received from the regulatory or public safety entity, to control the one or more UAVs based on the command from the regulatory or public safety entity.

10. The method of claim 9, further comprising:
tracking the location of the UAVs that are connected to the wireless network.

11. The method of claim 10, wherein the one or more UAVs, that are controlled by the command from the regulatory or public safety entity, are determined based on the tracked location of the UAVs.

12. The method of claim 9, wherein the assigned priority level is associated with a Quality of Service (QoS) Class Identifier (QCI) value of one.

13. The method of claim 9, further comprising:
receiving network traffic, from the UAVs, relating to UAV sensor data that is relevant to collision avoidance.

14. The method of claim 9, wherein the command from the regulatory or public safety entity includes a command to direct the one or more UAVs to perform an emergency landing or hover operation.

15. The method of claim 9, further comprising:
detecting when one or more of the UAVs approaches a restricted flying area; and
overriding control of the UAVs, by the UAV operators, in response to detection that the one or more of the UAVs is approaching the restricted flying area.

16. The method of claim 9, wherein the interface provided by the gateway device includes an Application Programming Interface (API) that accepts a standardized set of commands relating to control of the UAVs.

17. A gateway device for a wireless network, the gateway device comprising:
a memory device storing a set of processor-executable instructions; and
a processor configured to execute the processor-executable instructions, wherein executing the processor-executable instructions causes the gateway device to:
transmit, command and control traffic related to the operation of Unmanned Aerial Vehicles (UAVs) that are connected to the wireless network, as traffic that is assigned a higher priority level than traffic to the UAVs that is not UAV command and control traffic;
track, using the command and control traffic, locations of the UAVs that are connected to the wireless network; and
detect, from the command and control traffic and the tracked locations of the UAVs, when a particular one of the UAVs approaches a restricted flying area; and
override control of the particular one of the UAVs, from an operator of the particular one of the UAVs, in response to the detection that the particular one of the UAVs is approaching the restricted flying area.

18. The gateway device of claim 17, wherein the traffic that is assigned the higher priority level is associated with a Quality of Service (QoS) Class Identifier (QCI) value of one.

19. The gateway device of claim 17, wherein overriding control of the particular one of the UAVs includes transmitting an emergency landing or hover operation to the particular one of the UAVs.

20. The gateway device of claim 17, wherein executing the processor-executable instructions causes the gateway device to:
provide a standardized Application Programming Interface (API) to operators of the UAVs.
